(19) United States
(12) Patent Application Publication
(10) Pub. No.: US 2012/0061514 A1
(43) Pub. Date: Mar. 15, 2012

(54) PASSENGER SEAT DEVICE COMPRISING A COVERING UNIT

(75) Inventor: Jürgen Baumann, Bodman-Ludwigshafen (DE)

(73) Assignee: RECARO Aircraft Seating GmbH & Co., KG, Schwäbisch Hall (DE)

(21) Appl. No.: 13/259,977

(22) PCT Filed: Mar. 26, 2010
(86) PCT No.: PCT/EP2010/001911

§ 371 Date: Nov. 22, 2011

(30) Foreign Application Priority Data
Mar. 27, 2009 (DE) 10 2009 014 751.9

(51) Int. Cl. B60N 2/58; B64D 11/06

(52) U.S. Cl. 244/122 R

(57) ABSTRACT

A passenger seat device, in particular an airplane passenger seat device, which comprises a support assembly of stretched fabric for holding a stretched fabric element, the support assembly of stretched fabric comprising a frame unit.

### CROSS REFERENCE TO RELATED APPLICATIONS

This application is a U.S. national stage application of PCT/EP2010/001911 filed on Mar. 26, 2010, and claims priority to, and incorporates by reference, German patent application No. 10 2009 014 751.9 filed on Mar. 27, 2009.

### BACKGROUND

The invention is based on a passenger seat device, in particular an airplane passenger seat device.

Airplane passenger seats which comprise a seat part with a seat base, which is made of a plastics material and on which upholstery is positioned, are known.

The object of the invention is to provide a passenger seat device which is characterized by low weight and simple manufacture.

The object is achieved according to the invention by the features of claim 1, whilst advantageous embodiments and developments of the invention may be derived from the sub-claims.

### SUMMARY

A passenger seat device is proposed, in particular an airplane passenger seat device, which comprises a covering unit for retaining a covering part, said covering unit comprising a frame unit. As a result, a passenger seat device may be provided which has particularly low weight and which may be manufactured particularly easily. The invention is suitable for use, in particular, as an airplane passenger seat and namely, in particular, regarding the increasingly strict requirements from transport companies as regards the weight of cabin seating.

By the use of a frame unit, a covering part may be retained in a manner which is particularly robust and easy to maintain. In contrast to a solution in which a covering part is retained and/or supported by individual retaining points and/or supporting points which are spatially separate from one another, such as for example with the use of clamping elements or rolling elements for clamping and/or supporting the covering part, an at least substantially uniform tension over at least a substantial portion of the covering part may be advantageously achieved by means of a frame unit, whereby the service life of the covering part is positively affected. To this end, the frame unit advantageously forms a continuous set of clamping points over the extent of a frame element, said set of clamping points preferably extending over at least a substantial part of the extent of the covering part in its main direction of extension and/or in a direction oriented transversely thereto. Herein the frame element preferably exerts a clamping force on the covering part, said clamping force being oriented at least substantially perpendicular to the longitudinal direction of the frame element.

In a preferred embodiment, it is proposed that the covering unit is configured as a component of a seat part unit of the passenger seat device. With the use of a covering part covered by the frame unit in a seat part unit of a passenger seat, a considerable portion of the weight of a seat part may be saved. Usually, this weight is due to the use of a seat base made of a plastics material and of its mounting, both of which may be dispensed with by the use of the passenger seat device according to the invention. “Seat part unit” is intended, in particular, to be understood as a unit which is provided for forming a seat surface for supporting a passenger's buttocks, said seat surface being oriented horizontally relative to a floor in at least one position, in contrast to a backrest surface.

In a particularly advantageous manner, the frame unit preferably has at least two frame portions which are preferably configured as elongate components, which are spaced apart from one another in a clamping direction and span a space in which a main surface of the covering part is arranged. “Clamping direction” is intended, in particular, to be understood as a direction in which a clamping force produced by the frame portions is oriented.

Relative to a seat direction of the passenger seat device, a clamping force produced by the frame portions may be oriented substantially parallel or substantially transversely to the seat direction. “Seat direction” is intended to be understood, in particular, as a direction which, when the passenger is seated in a standard position, substantially corresponds to the direction in which the passenger's thighs extend from the buttocks to the knee region. In an upright position of a seat, in which a backrest is oriented perpendicular to a floor, the seat direction is oriented parallel to a floor and perpendicular to the backrest surface formed by the backrest. If the passenger seat device is used for an airplane passenger seat, the seat direction typically corresponds to the flight direction. A clamping force which is oriented “substantially parallel” or “substantially transversely” to the seat direction is intended to be understood, in particular, as a clamping force which, projected onto the seat direction as well as a direction perpendicular thereto, has its largest component in the seat direction respectively in the direction perpendicular thereto.

However, a particularly ergonomic configuration of the passenger seat device may be achieved if the frame unit comprises frame portions which are provided to cooperate in producing a clamping force for stretching the covering part, said clamping force being oriented substantially transversely to the seat direction. In a particularly advantageous manner, the clamping force may be oriented perpendicular to the seat direction.

In this context, an advantageous lateral support of the covering part may be achieved if the frame portions are spaced apart from one another in a direction transversely to the seat direction and span a space in which the covering part is arranged in a retained state. In this case, the frame portions preferably extend at least substantially in the seat direction. It is intended to be understood thereby that, when the extent of the frame portions is projected in the seat direction and in a direction perpendicular thereto, in each case the frame portions have a greatest component of extension, which is oriented in the seat direction. In particular, the frame portions may be oriented in the seat direction. A particularly simple construction may be achieved, moreover, if the frame portions are aligned parallel to one another, wherein embodiments are nevertheless possible in which the frame portions, which are spaced apart from one another, are inclined relative to one another.

Moreover, the covering part may be retained in a robust manner if the frame unit has a transverse portion which connects the frame portions. As a result, the covering part is advantageously encompassed by at least three adjacent sides of the frame unit. Herein the transverse portion preferably extends substantially perpendicular to the frame portions.

A particularly advantageous arrangement of the covering unit in an existing seat structure may be achieved if the passenger seat device comprises two supporting bars, wherein the frame unit is arranged between the supporting bars. In this case, by an arrangement “between the supporting bars” it is intended to be understood, in particular, that, relative to a vertical direction perpendicular to a floor, a vertical projection of the frame unit onto a horizontal plane which connects the supporting bars is arranged between the supporting bars. In particular, in a direction transversely to the seat direction, the supporting bars span a space in which the frame unit is arranged. The corresponding technical term for the supporting bars is “seat dividers”. Said supporting bars preferably extend in the seat direction, are spaced apart from one another in a direction transversely to the seat direction and serve, in particular, for mounting a backrest and/or an armrest.

In this context, it is proposed, in particular, that the frame unit comprises a frame element which is fastened to at least one supporting bar, whereby additional components and additional constructional space for fastening the frame unit may be saved.

Moreover, components and constructional space may be saved if the passenger seat device comprises a support unit with a support means, wherein relative to the seat direction, the frame unit has a front region, and the support means forms at least one support point on which the frame unit is supported in its front region. As a result, additional support for the front region of the frame unit may be dispensed with, and forces acting on the frame unit may be easily and directly transmitted to the support unit. The frame unit may directly bear against the support point of the support means or a further connection means may be provided, which is arranged at the support point of the support means and on which the frame unit is supported. Herein the support unit is preferably mounted by means of a mounting unit on a floor and serves, in particular, to transfer forces which act on a backrest, an armrest and/or a seat part to the mounting unit. “Front region” of the frame unit is intended to be understood as a region forming the front end of the frame unit, said region extending over maximally a third, preferably maximally a fourth of the maximum extent of the frame unit in the seat direction.

It is also proposed that the support means extends perpendicular to the seat direction, whereby a large support surface may be achieved for supporting the frame unit.

Advantageously, the support unit serves for supporting at least one supporting bar. If the frame unit is fastened to at least one supporting bar, forces loading the frame unit may additionally be transmitted to the support unit via the supporting bar.

Moreover, the comfort for a passenger may be increased if the passenger seat device comprises an upholstery unit which, in a mounted state, is positioned on the covering unit.

In a further embodiment of the invention it is proposed that, relative to the seat direction, the frame unit forms a front end and has a first partial region which, in a mounted state, has a first orientation, in particular a horizontal orientation, and has a second partial region which is adjacent to the first partial region and to the front end, and which is inclined downward. As a result, a high degree of comfort for a passenger may be achieved with a structurally simple implementation, wherein shear forces acting on the underside of the passenger's thighs may be reduced in the region of the front edge of the seat. The front end of the frame unit may be configured in the form of a front edge which extends, for example, transversely to the seat direction.

If the passenger seat device is provided with an upholstery unit, said upholstery unit advantageously has, in a region above the inclined partial region of the frame unit, a thickness which increases toward the front end to form a horizontal seat surface. As a result, particularly low shear forces may be achieved in the front region.

In a preferred embodiment, it is proposed that the passenger seat device comprises a covering part with a retaining portion in which a frame element of the frame unit is inserted in a retained state of the covering part, whereby a particularly simple mounting may be achieved.

Moreover, weight may be advantageously reduced if the frame unit has a frame element which is configured as a tube.

### BRIEF DESCRIPTION OF THE DRAWINGS

Further advantages are revealed from the following description of the drawings. Exemplary embodiments of the invention are shown in the drawings. The description and the claims contain numerous features in combination. A person skilled in the art will reasonably consider the features individually and combine them to achieve further expedient combinations.

In the drawings:

FIG. 1 is a perspective view of a passenger seat with a covering unit which comprises a frame unit,

FIG. 2 is a detailed view of the frame unit and of a covering part,

FIG. 3 is a lateral view of the covering unit and of an upholstery unit fastened thereto,

FIG. 4 is a view of the passenger seat of FIG. 1 with an alternative embodiment of a frame unit, and

FIG. 5 is a detailed view of a connection point for the frame unit of FIG. 3.

### DETAILED DESCRIPTION OF THE PREFERRED EMBODIMENTS

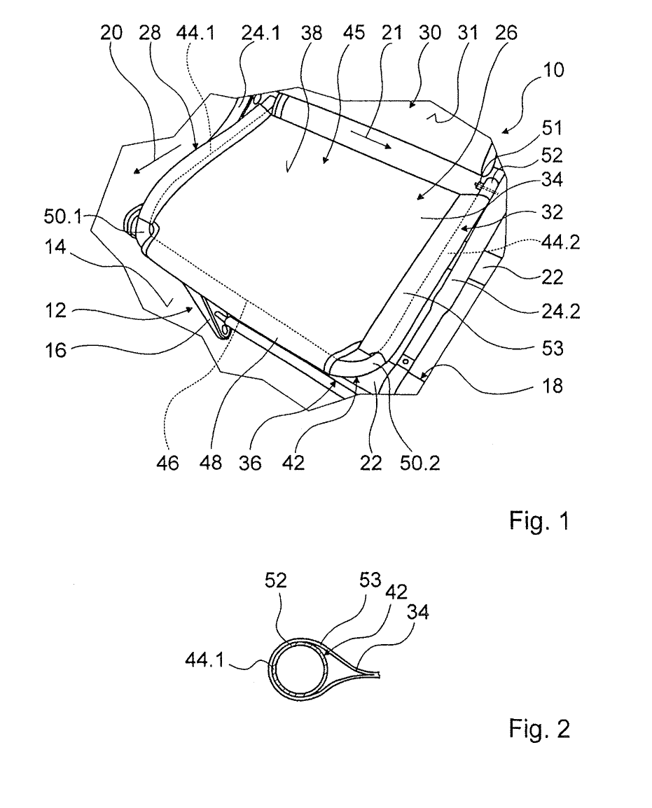

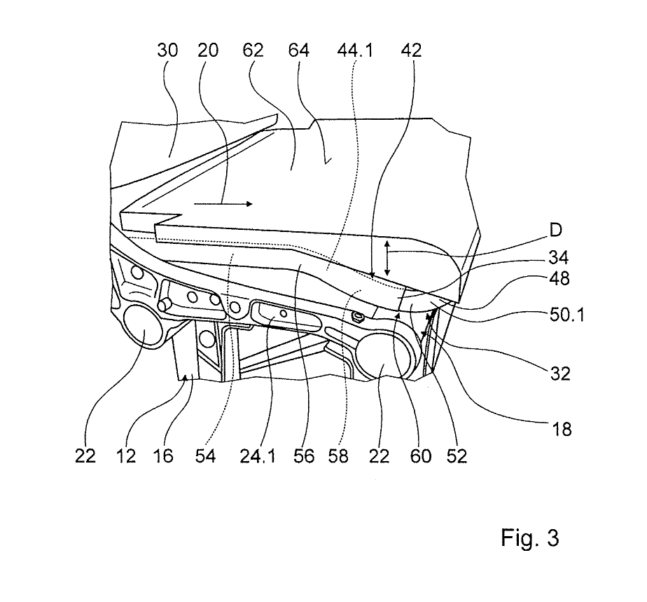

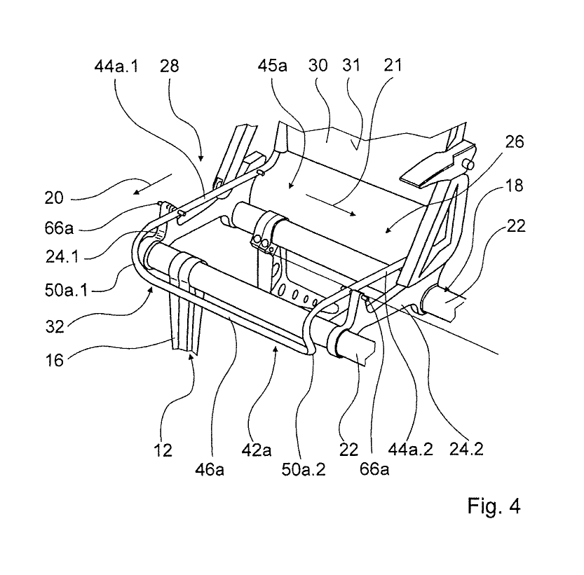

FIG. 1 shows a passenger seat 10 configured as an airplane passenger seat in a perspective view. Said passenger seat 10 comprises a mounting unit 12 which serves for mounting on a floor 14 and, to this end, comprises base elements 16, which are fastened, in a conventional manner, to a fastening rail not shown in the figure, which is fastened to the floor 14. By means of the base elements 16, in particular, a support unit is mounted which serves for receiving seat forces and for the deflection thereof onto the mounting unit 12. The support unit 18 comprises two support means 22 extending parallel to one another and transversely to a seat direction 20, which may optionally serve for connecting a plurality of passenger seats 10 in a seat row (see also FIG. 4). The support means 22 may, for example, in each case be configured as a supporting tube (FIG. 3). Moreover, the passenger seat 10 has a pair of elongate supporting bars 24.1, 24.2 which extend in the seat direction 20, are oriented parallel to one another, and connect the support means 22 in the seat direction 20 (see also FIGS. 3 and 4). A technical term for the supporting bars 24 in the relevant field is “seat dividers”. They are spaced apart from one another in a direction 21 transversely to the seat direction 20 and in this direction 21 span a space 26 in which a seat part unit 28 is arranged, the seat part unit 28 being described below in more detail. The supporting bars 24, which are supported by the support unit 18, serve, in particular, for mounting a backrest 30, which is partially shown in the figure. The backrest 30 may be mounted rigidly or pivotably at the supporting bars 24 and forms a backrest surface 31. The seat direction 20 is defined herein as a direction which, in an upright position of the backrest 30 in which the backrest surface 31 is oriented perpendicular to the floor 14, is oriented perpendicular to the backrest surface 31, parallel to the floor 14 and leads away from the backrest 30. If the passenger seat 10 is used in the seating for an airplane cabin, the seat direction 20 typically corresponds to the flight direction. The direction denoted by the reference numeral 21, in which the support means 22 extend, is oriented parallel to the floor 14 and perpendicular to the seat direction 20.

The seat part unit 28 has a covering unit 32 which retains a covering part 34 by means of a retaining unit 36. The covering part 34 is made of a fabric, preferably of a fireproof fabric, and may be configured in the form of a woven fabric, a knitted fabric, or in any other form which appears expedient to the person skilled in the art. In a retained state of the covering part 34, a main surface 38 is formed by means of the covering unit 32 and namely, in particular, by means of the upper face of the covering part 34, said main surface 38 being oriented at least substantially parallel to the floor 14. As a result, the main surface is preferably used for receiving and transmitting seat forces which are produced when a passenger sits down and/or is seated, and at least substantially comprise a vertical component perpendicular to the floor 14.

The retaining unit 36 comprises a frame unit 42, by means of which the covering part 34 is stretched in its retained state. The frame unit 42 is arranged in the space 26 spanned by the supporting bars 24 or, in other words, it is arranged between the supporting bars 24.1, 24.2 (see also FIG. 4) relative to the direction 21 perpendicular to the seat direction 20.

The frame unit 42, which is partially covered by the covering part 34, is shown in broken lines for the sake of clarity. It comprises two frame portions 44.1, 44.2 which are of elongate configuration, which extend at least substantially in the seat direction 20, and which oppose one another relative to the direction 21. They are spaced apart from one another in the direction 21 transversely to the seat direction 20, and span a space in which the covering part 34, in particular the main surface 38 formed by the covering part 34, is arranged. The frame portions 44.1, 44.2 are oriented parallel to one another and cooperate in producing clamping forces which stretch the covering part 34 and are substantially oriented in the direction 21, transversely to the seat direction 20.

Moreover, the frame unit 42 has a transverse portion 46 which is of elongate configuration and extends in the direction 21 transversely to the seat direction 20. The transverse portion 46 is arranged, relative to the seat direction 20, in the front region of the passenger seat 10, which is remote from the backrest region. Herein said transverse portion 46 forms a front end of the frame unit 42 in the form of a front edge 48, in particular a rounded front edge 48, of the frame unit 42. The transverse portion 46, which extends perpendicular to the frame portions 44.1, 44.2, connects the frame portions 44.1, 44.2 over rounded corner regions 50.1, 50.2.

In the exemplary embodiment considered, the frame portions 44.1, 44.2 and the transverse portion 46 are integrally connected over the corner regions 50.1, 50.2. To this end, the frame unit 42 has a one-piece frame element 52, which forms the frame portions 44.1, 44.2 and the transverse portion 46. The frame element is fastened, in the rear region of the seat part unit 28 opposing the front edge 48 relative to the seat direction 20, to the supporting bars 24, which oppose one another relative to the direction 21, by means of a fastening unit 51, for example by means of a screw connection. It may be imagined that, in an alternative exemplary embodiment, the frame unit 42 has a plurality of frame elements which form the frame portions 44.1, 44.2 and the transverse portion 46 as separately produced components, and which may be fastened to one another, for example, by means of a soldered, riveted or screw connection, etc. In this case, two frame elements opposing one another relative to the direction 21, each of which forms a frame portion 44.1 respectively 44.2, are fastened to the corresponding supporting bar 24.

FIG. 2 shows a detailed view of the frame unit 42 and the covering part 34 in a sectional view perpendicular to the main direction of extension of the frame portion 44.1 of the frame unit 42. The covering part 34 has retaining portions 53 for coupling to the frame unit 42. Said retaining portions 53 are configured in the form of an insertion region in which the frame portions 44 and the transverse portion 46 are inserted. In the retained state of the covering part 34, the frame portions 44.1, 44.2 and the transverse portion 46, and/or a frame element 52 forming the frame portions 44.1, 44.2 and/or the transverse portion 46 are each encompassed by a retaining portion 53. The retaining portions 53 are connected, for example, to the main surface 38 via a stitched seam in the material of the covering part 34. As may be gathered from FIG. 2, the frame element 52 has the shape of a cylinder. For example, the frame element 52 is configured as a tube.

In FIG. 3, the arrangement of FIG. 1 is shown in a lateral view. In particular, the mounting unit 12 is shown comprising a base element 16, the support unit 18 mounted by the mounting unit 12 with—relative to the seat direction 20—a rear support means 22 and a front support means 22 in the form of a support tube, the supporting bar 24.1, at which the backrest 30 is mounted while being fastened to the support means 22, and the frame unit 42, of which the frame portion 44.1 and the corner region 50.1 are shown. The frame portion 44.1 is formed by the frame element 52, which is fastened to the supporting bar 24.1 in the rear region of the passenger seat 10 (see FIG. 1). As has been mentioned above, the frame portion 44.1 substantially extends in the seat direction 20. Herein the frame portion 44.1 has a first partial region 54 which is oriented in the seat direction 20, i.e. in particular parallel to the floor 14, and is at least half the total length of the frame portion 44.1. Herein the length of the frame portion 44.1 corresponds to its extent from a rear end, which is fastened to the support member 24.1, to the transition area with the rounded corner region 50.1. The first horizontal partial region 54 merges at an angle point 56 with a second partial region 58 which is inclined downward relative to the first partial region 54. The first partial region 54 and the second partial region 58 form an obtuse angle at the angle point 56. The angle point 56, which constitutes the front end region of the horizontally oriented first partial region 54, is arranged, relative to the seat direction 20, in front of the front support means 22. In other words, the vertical projection of the angle point 56 onto a horizontal plane connecting the front support means 22 to the support means 22, is arranged between the two support means 22.

The second partial region 58 adjoining the first partial region 54 adjoins the front end of the frame unit 42, i.e. the front edge 48 formed by the corner region 50.1 and the transverse portion 46 (not visible). Herein the second partial region 58 merges with the corner region 50.1 and forms therewith an obtuse angle, wherein the corner region 50.1 is oriented parallel to the floor 14.

The front support means 22 forms support points 60 on which the frame unit 42 and namely, in particular, the corner regions 50.1, 50.2 are supported in the front region of the frame unit 42. In the exemplary embodiment under consideration, the frame element 52 of the frame unit 42 is located directly on the front support means 22, wherein a variant is conceivable with an intermediate element, for example a flexible intermediate element, which is arranged between the frame element 52 and the support means 22.

An upholstery unit 62 is positioned on the covering unit 32 and namely, in particular, on the main surface 38 formed by the covering part 34 (see FIG. 1). Said upholstery unit 62 may be fastened, for example by means of a hook-and-loop fastener (not shown), to the covering part 34. The upholstery unit 62 forms a seat surface 64 extending substantially horizontally. To form this seat surface 64, the upholstery unit 62 has a thickness D which increases,—relative to the vertical direction perpendicular to the floor 14—above the inclined partial region 58, from the angle point 56 of the frame unit 42 toward the front edge 48.

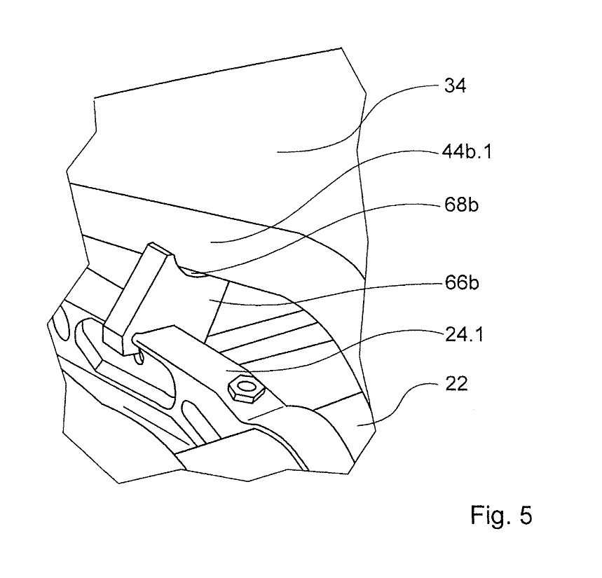

FIGS. 4 and 5 show the passenger seat 10 with alternative embodiments of a seat part unit 28. In order to avoid unnecessary repetition, the following description is limited to differences from the above-described exemplary embodiment. Components which have the same function as in the first exemplary embodiment are denoted by the same reference numerals, wherein the assignment thereof to the alternative exemplary embodiments is denoted by adding the letter “a” or “b”. For features which are not described below, reference is made to the above description.

The seat part unit 28 has a frame unit 42a comprising frame portions 44a.1 and 44a.2, which are oriented parallel to one another and extend in the seat direction 20. Said frame portions 44a.1 and 44a.2 are spaced apart from one another in the direction 21 and form a space 45a in which, in the mounted state, a covering part 34 (not shown) is arranged. Herein each frame portion 44a extends from a rear end region, which is fastened to a supporting bar 24, to a front horizontal end region, which is arranged relative to the vertical direction perpendicular to the floor 14 above the front support means 22. A connection means 66a fixed to each supporting bar 24.1 respectively 24.2 is provided for supporting the frame portions 44a in the front region of the frame unit 42, said connection means 66a serving to transmit a force from the frame unit 42a to a supporting bar 24.1 and/or 24.2. As a result, the frame portions 44a.1, 44a.2 are supported in the rear region and in the front region of the supporting bars 24.1, 24.2. Each frame portion 44a.1, 44a.2 merges in the front region, over a downwardly inclined corner region 50a.1 respectively 50a.2, with a transverse portion 46a which extends in the direction transversely to the seat direction 20. The transverse portion 46a extends parallel to the front support means 22 and, relative to the seat direction 20, is arranged in front of the support means 22.

In the embodiment shown in FIG. 4, the connection means 66a abut, relative to the seat direction 20, laterally on the frame portions 44a. To this end, they are oriented in particular horizontally.

FIG. 5 shows a detailed view of the passenger seat 10 with an alternative embodiment of a seat part unit. This exemplary embodiment substantially corresponds to the embodiment shown in FIG. 4, wherein the following description is limited to the differences from this embodiment.

The embodiment shown in FIG. 5 differs from the embodiment of FIG. 4 in an alternative configuration of a connection means 66b. Said connection means 66b is supported in its lower end region on a supporting bar and has in its upper end region a recess 68b receiving a frame portion 44b.1, which corresponds to the above-described frame portion 44a.1. Thus, the frame portions 44b are supported from below by connection means 66b, which oppose one another relative to the direction 21.

1. A passenger seat device, in particular an airplane passenger seat device, comprising a covering unit for retaining a covering part, said covering unit comprising a frame unit.

2. The passenger seat device as claimed in claim 1, further comprising a seat part unit, wherein the covering unit is a component of the seat part unit.

3. The passenger seat device as claimed in claim 1, further comprising a seat direction, wherein the frame unit comprises frame portions which are provided to cooperate in producing a clamping force for stretching the covering part, said clamping force being oriented substantially transversely to the seat direction.

4. The passenger seat device as claimed in claim 3, wherein the frame portions are spaced apart from one another in a direction transversely to the seat direction, and span a space in which the covering part is arranged in a retained state.

5. The passenger seat device as claimed in claim 3, wherein the frame unit has a transverse portion which connects the frame portions.

6. The passenger seat device as claimed in claim 1, further comprising two supporting bars, wherein the frame unit is arranged between the supporting bars.

7. The passenger seat device as claimed in claim 6, wherein the frame unit comprises a frame element which is fastened to at least one supporting bar.

8. The passenger seat device as claimed in claim 1, further comprising a support unit with at least one support means and by a seat direction, wherein, relative to the seat direction, the frame unit has a front region, and the support means forms at least one support point, on which the frame unit is supported in its front region.

9. The passenger seat device as claimed in claim 8, wherein the support means extends in a direction perpendicular to the seat direction.

10. The passenger seat device as claimed in claim 8 wherein the support unit is provided for supporting at least one supporting bar.

11. The passenger seat device as claimed in claim 1, further comprising an upholstery unit which, in a mounted state, is positioned on the covering unit.

12. The passenger seat device as claimed in claim 1, further comprising a seat direction, wherein, relative to the seat direction, the frame unit forms a front end and has a first partial region, which in the mounted state has a first orientation, and a second partial region, which is adjacent to the first partial region and to the front end, the second partial region being inclined downward.

13. The passenger seat device as claimed in claim 11, wherein, in a region above the inclined partial region of the frame unit, the upholstery unit has a thickness which increases toward the front end to form a horizontal seat surface.

14. The passenger seat device as claimed in claim 1, further comprising a covering part with a retaining portion in which a frame element of the frame unit is inserted in a retained state of the covering part.

15. The passenger seat device as claimed in claim 1, wherein the frame unit has a frame element which is configured as a tube.

16. The passenger seat device as claimed in claim 6, wherein the support unit is provided for supporting at least one supporting bar.

17. The passenger seat device as claimed in claim 12, wherein, in a region above the inclined partial region of the frame unit, the upholstery unit has a thickness which increases toward the front end to form a horizontal seat surface.
